(19) United States
(12) Patent Application Publication
(10) Pub. No.: US 2007/0097137 A1
(43) Pub. Date: May 3, 2007

(54) Utilities, methods and device providing vector images that may be updated to reflect the status of a device

(76) Inventors: Andrew Christopher Walton, Rocklin, CA (US); Christopher William Brown, Fort Collins, CO (US); Bryan J. Jacquot, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,272

(22) Filed: Oct. 27, 2005

(51) Int. Cl. G09G 5/00

(52) U.S. Cl. 345/581

(57) ABSTRACT

In one embodiment, in response to receiving an image request, a computer-implemented method 1) retrieves a vector image from a device that is a target of the image request, the vector image illustrating at least a portion of the device, and 2) retrieves status information for the device. The vector image is then formatted by A) identifying a first tag within the vector image, the first tag being associated with one or more vectors that define a fillable area of the vector image, and B) in accord with the retrieved status information, replacing the first tag with a second tag, the second tag identifying a status element to be displayed in the fillable area. A formatted version of the vector image is then returned. Other embodiments are also disclosed.

### BACKGROUND

The management of a device is typically aided by providing its user with a means to graphically visualize the device. In some cases, one or more images of a device and its components may be included within paper or electronic documentation (e.g., a user manual). In other cases, a device may be provided with stickers showing one or more views of the device's interior components.

In still other cases, images of a device may be incorporated into a management tool for the device. For example, a print driver may display an image of the printer to which it corresponds, or a server management tool may display various images associated with the server components of which the management tool is aware or can manage (e.g., the server's memory modules, interfaces, or storage disks).

Many devices for which graphical images are needed are subject to change. That is, the devices may be upgradeable such that additional components (e.g., memory modules, interfaces, or storage disks) may be inserted into or attached to the device. Thus, an issue facing the image creator is whether to draw an image of each configuration of the device or draw a single “exemplary” image in which the device is depicted in one particular “default” configuration.

A device may also be subject to change over its lifecycle. That is, the styling of the device's exterior, the suppliers of its internal components, its “default” configuration, and even its available features can change over its lifecycle. Thus, any images pertaining to the first generation of the device may not accurately depict later generations of the device.

As one can appreciate, the creation and maintenance of graphical images for a device can present a significant burden for both device manufacturers and third-party device supporters (e.g., management tool developers).

### SUMMARY OF THE INVENTION

In one embodiment, an image formatting utility comprises code to, in response to receiving an image request from a device management tool, 1) retrieve a vector image from a device that is a target of the image request, and 2) retrieve status information for the device. Code is also provided to format the vector image by A) identifying a first tag within the vector image, the first tag being associated with one or more vectors that define a fillable area of the vector image, and B) in accord with the retrieved status information, replacing the first tag with a second tag, the second tag identifying a status element to be displayed in the fillable area. Additional code then returns a formatted version of the vector image to the device management tool.

In another embodiment, an article of manufacture comprises computer-readable media, and computer-readable code that is stored on the computer-readable media. The computer-readable code includes code to, in response to receiving an image request, 1) retrieve a vector image from a device that is a target of the image request, the vector image illustrating at least a portion of the device; 2) retrieve status information for the device; 3) format the vector image by, A) identifying a first tag within the vector image, the first tag being associated with one or more vectors that define a fillable area of the vector image, and B) in accord with the retrieved status information, replacing the first tag with a second tag, the second tag identifying a status element to be displayed in the fillable area; and 4) return a formatted version of the vector image.

In yet another embodiment, an image formatting utility comprises code to, in response to receiving an image request from a device management tool, 1) retrieve a vector image from a device that is a target of the image request, and 2) retrieve status information for the device. Code is also provided to format the vector image by A) identifying a first tag within the vector image, the first tag being associated with one or more vectors that define a fillable area of the vector image, and B) in accord with the retrieved status information, linking the first tag to a status element to be displayed in the fillable area. Additional code then returns a formatted version of the vector image to the device management tool.

In an additional embodiment, an article of manufacture comprises computer-readable media, and computer-readable code that is stored on the computer-readable media. The computer-readable code includes code to, in response to receiving an image request, 1) retrieve a vector image from a device that is a target of the image request, the vector image illustrating at least a portion of the device; 2) retrieve status information for the device; 3) format the vector image by, A) identifying a first tag within the vector image, the first tag being associated with one or more vectors that define a fillable area of the vector image, and B) in accord with the retrieved status information, linking the first tag to a status element to be displayed in the fillable area; and 4) return a formatted version of the vector image.

In still another embodiment, a computer-implemented method for formatting images of a device comprises, in response to receiving an image request from a device management tool, 1) retrieving a vector image from a device that is a target of the image request, and 2) retrieving status information for the device. The vector image is then formatted by A) identifying a first tag within the vector image, the first tag being associated with one or more vectors that define a fillable area of the vector image, and B) in accord with the retrieved status information, replacing the first tag with a second tag, the second tag identifying a status element to be displayed in the fillable area. A formatted version of the vector image is then returned to the device management tool.

In another embodiment, a computer-implemented method for formatting images of a device comprises, in response to receiving an image request from a device management tool, 1) retrieving a vector image from a device that is a target of the image request, and 2) retrieving status information for the device. The vector image is then formatted by A) identifying a first tag within the vector image, the first tag being associated with one or more vectors that define a fillable area of the vector image, and B) in accord with the retrieved status information, linking the first tag to a status element to be displayed in the fillable area. A formatted version of the vector image is then returned to the device management tool.

In another embodiment, a device comprises a non-volatile memory in which an image illustrating at least a portion of the device is stored. The image comprises a plurality of vectors and an tag. The tag is 1) associated with one or more vectors that define a fillable area of the vector image, and 2) identifies a status element that is external to the vector image. The device also comprises an interface to, upon receiving a request for the vector image, return the vector image.

Other embodiments are also disclosed.

### BRIEF DESCRIPTION OF THE DRAWINGS

Illustrative embodiments of the invention are illustrated in the drawings, in which:

FIG. 1 illustrates an exemplary system in which an image formatting utility may be used;

FIG. 2 illustrates a first embodiment of the image formatting utility shown in FIG. 1;

FIG. 3 illustrates an exemplary vector image;

FIG. 4 illustrates a display of the vector image shown in FIG. 3; and

FIG. 5 illustrates a second embodiment of the image formatting utility shown in FIG. 1.

### DETAILED DESCRIPTION

One development that has eased the burden of creating and maintaining graphical images for a device is the electronic storage of a device's images within the device itself. For example, different images pertaining to different views and/or components of a device may be saved as Scalable Vector Graphics (SVG) images, or other easy-to-manipulate image types, and stored within a non-volatile memory of the device (preferably, but not always, in the device's firmware). Thus, a management tool for the device no longer needs to provide its own set of images for the device. Rather, the management tool need only be provided with abilities to 1) query the device to retrieve an image of the device, and 2) format the image to reflect the current state of the device. In this manner, the developer of the management tool need not be concerned with how the device looks, and can instead focus on how the device functions and is managed.

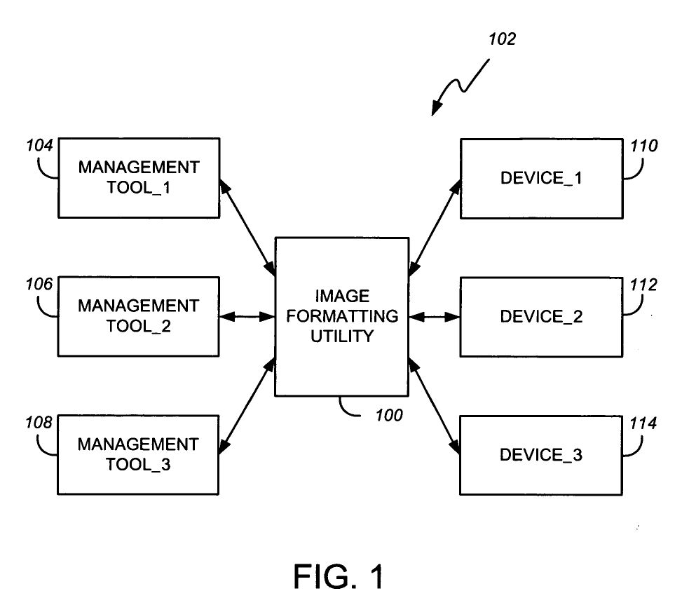

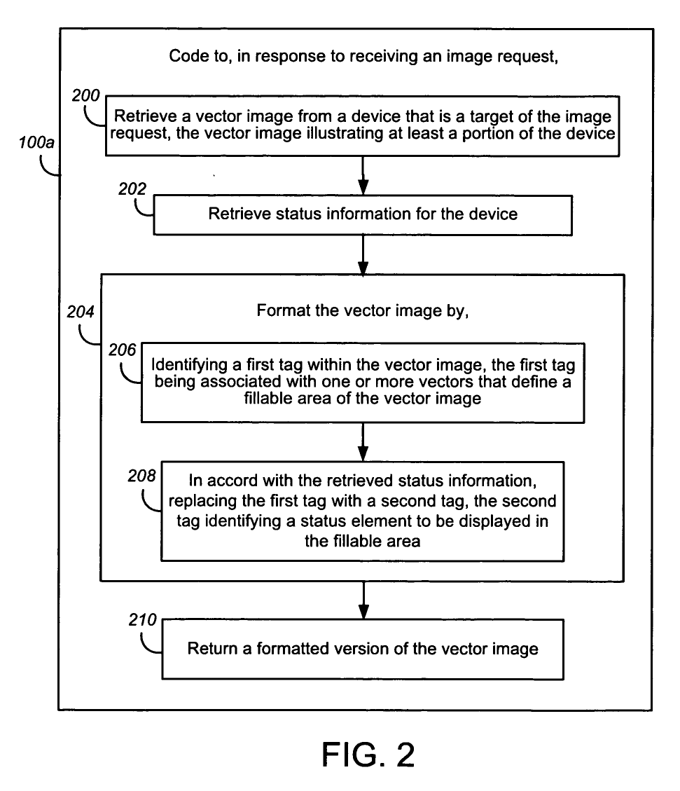

To further ease a management tool developer's burden of having to work with device images, an image formatting utility 100 (FIGS. 1, 2 & 5), and system 102 incorporating same, are disclosed herein. By way of example, the “utility” 100 may take the form of an application or browser plug-in that is embodied in computer-readable code stored on one or more computer-readable media. The computer-readable media may include, for example, any number or mixture of fixed or removable media (such as one or more fixed disks, random access memories (RAMs), read-only memories (ROMs), or compact discs), at either a single location or distributed over a network.

Before describing the image formatting utility 100 in detail, an exemplary system 102 (FIG. 1) in which the image formatting utility 100 may be used will be described.

The system 102 comprises one or more device management tools 104, 106, 108 for generating image requests, and one or more devices 110, 112, 114 that may be targets of the image requests. Each of the devices 110-114 is provided with a non-volatile memory in which one or more images (i.e., an image set) illustrating at least a portion of the device is stored. Assuming that the management tools 104-108 and devices 110-114 comprise interfaces that are compatible with those of the image formatting utility 100, the utility 100 may 1) receive plural image requests from any one or more of the management tools 104-108, and 2) in responding to the plural image requests, format images retrieved from a plurality of the devices 110-114 and return the formatted images to the requesting ones of the management tools 104-108. Of note, the management tools 104-108 and devices 110-114 of the system 102 have no direct link to, nor dependence on, each other. Thus, one or the other can easily be modified or appended to without affecting the other. Furthermore, the image(s) stored within the devices 110-114 can be updated without any need to worry about how the updated images will be drawn by the utility 100 or the management tools 104-108.

The management tools 104-108 of the system 102 may take various forms, including, for example, those of a: print driver, configuration manager, licensing manager, server manager, system manager, or network manager. In one embodiment of the system 102, one or more of the device management tools 104-108 may present a user interface (e.g., a graphical user interface (GUI)) through a web browser.

The devices 110-114 of the system 102 may also take various forms, including, for example, those of a: server, computer system, printer, or network. Further, the devices in which images are stored may be parts of other devices. For example, images may be stored in a memory of a computer motherboard, while additional images may be stored in a configurable video or networking card that has been inserted into a slot of the motherboard.

In one embodiment, the image or images (i.e., image set) stored within a device comprise SVG images. SVG is a language for describing two-dimensional graphics and graphical applications in extensible markup language (XML). SVG specifications are published by the World Wide Web Consortium (W3C®). SVG images are particularly suited to being stored in a device as a result of their small storage requirements, scalable size, and configurability. Alternately, a device's image set may comprise other types of easy-to-manipulate images, such as other vector-based images (e.g., postscript images).

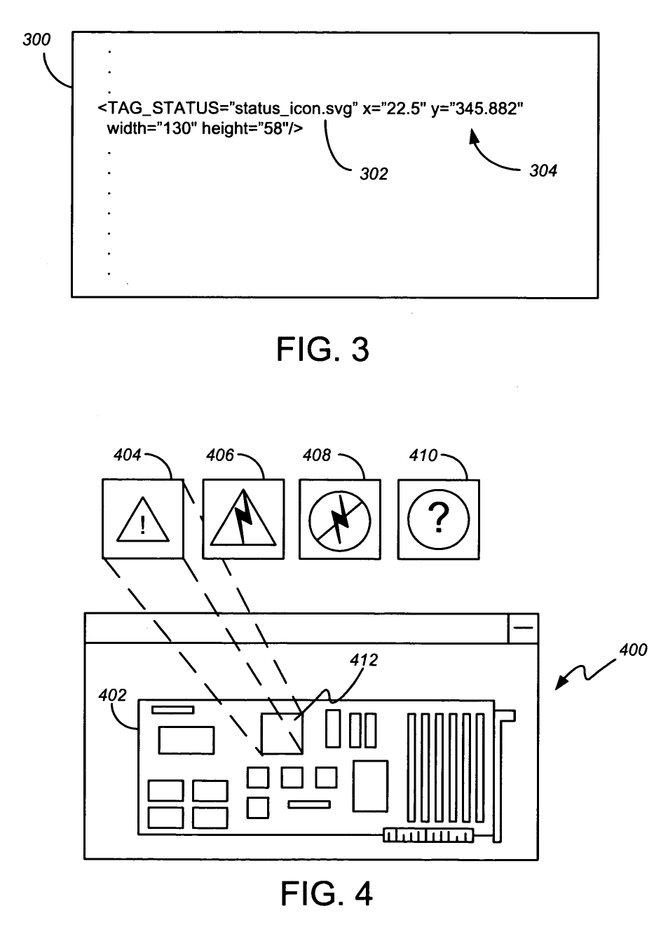

Each device 110-114 may store its image set in a non-volatile memory. The images in each image set illustrate at least a portion of the device in which they are stored, and in some cases may illustrate different portions or views of the device. For purposes which will become clear later in this description, one or more of the stored images may be vector images (see vector image 300, FIG. 3). Each of the vector images may comprise a plurality of vectors and one or more embedded tags (e.g., the file name “status_icon.svg” 302, FIG. 3). At least some of the embedded tags are associated with one or more vectors (e.g., vectors 304) that define a fillable area of its vector image.

In some cases, an embedded tag may be associated with a status element that is stored: 1) within the vector image (e.g., a set of vectors that may be made “visible” or “invisible” by virtue of their being referenced by an embedded tag); 2) apart from the vector image, but within the non-volatile memory of a device (e.g., in a file stored apart from a primary vector image); or 3) externally to the device. In other cases, an embedded tag may be associated with a placeholder element (e.g., a name of a file that does not exist absent some other process defining or providing its content).

In a simple embodiment, each of the devices 110-114 need only have an ability to fetch and return its stored image set (possibly only one image). However, in other embodiments, a device interface may have an ability to fetch a particular image (e.g., via address, number or type). A device interface may also return component presence and status information for the device, although it need not.

Although the exemplary system 102 illustrates the utility 100 being stored and executed apart from any management tool 104-108 or device 110-114, the utility 100 could alternately be stored and executed locally to a particular management tool or device (e.g., within the device).

Having described exemplary contexts in which the utility 100 may be used, the utility 100 will now be described in greater detail.

FIG. 2 illustrates a first embodiment 100a of the utility 100. The utility 100a comprises code 200, 202 to, in response to receiving an image request from a device management tool, 1) retrieve a vector image from a device that is a target of the image request, and 2) retrieve status information for the device. The utility 100a also comprises code 204 to format the vector image by A) identifying 206 a first tag within the vector image, the first tag being associated with one or more vectors that define a fillable area of the vector image, and B) in accord with the retrieved status information, replacing 208 the first tag with a second tag, the second tag identifying a status element to be displayed in the fillable area. In this manner, the placement and size of the fillable area is determined by the retrieved image, but the content of the fillable area is determined by the utility 100a.

Additional code 210 is provided to return a formatted version of the vector image to the device management tool that requested the image.

By way of example, the status element that is used to fill the fillable area may comprise a status icon and/or text. If the status element is a status icon, and if the image being formatted is a vector image, it is preferable that the status element be a vector image so that it may be easily resized with the vector image in which it is placed. However, a status icon may also take the form of a raster image.

FIG. 4 illustrates a GUI 400 that displays a vector image 402. By way of example, the vector image 402 might be a rendered version of the vector image 300 shown in FIG. 3. The vector image 402 is shown to have a fillable area 412 that may be filled by one of a number of status icons 404, 406, 408, 410.

In some cases, the fillable area of the retrieved image may be a portion of the image that is always displayed (e.g., as shown in FIG. 4). In other cases, the fillable area may define a portion of the vector image that is displayed in pop-up form, upon user interaction with a display of the vector image (e.g., an image portion that is displayed upon a user hovering over another portion of the image with a graphical pointer). In either case, the fillable area may define a portion of the image that does, or does not, overlay other vectors of the vector image.

In some embodiments, one or both of the tags may be file names. When the first tag is a file name, the file name may correspond to a file that specifies some sort of default status element for filling the fillable area. Or, the file name may specify a status element that is merely a “placeholder element” that does not exist. When the second tag is a file name, the file name may correspond to a file that specifies a status element corresponding to the current status of the device. For example, FIG. 4 illustrates four alternate status icons 404, 406, 408, 410, each of which may be saved in one of a plurality of files having names corresponding to the statuses that are represented by the status icons, and one of which may be selected to fill the fillable area 412.

One or both of the tags may also be pointers, such as pointers to subsets of vectors within a retrieved vector image (which subsets of vectors are marked as “invisible” absent their being pointed to by an appropriate tag). In this manner, the second tag may point to a different set of vectors than the first tag. Or, for example, the first tag may point to a subset of vectors within the vector image, and the second tag may point to a subset of vectors or file that is external to the vector image (and possibly external to the device from which the vector image was retrieved).

In some cases, the utility 100a may retrieve (or receive) the second tag from the device from which a vector image is retrieved. In other cases, the utility 100a may retrieve (or receive) the second tag from a device management tool. In still other cases, the utility 100a may select the second tag from among tags corresponding to a plurality of status elements maintained by the utility 100a itself.

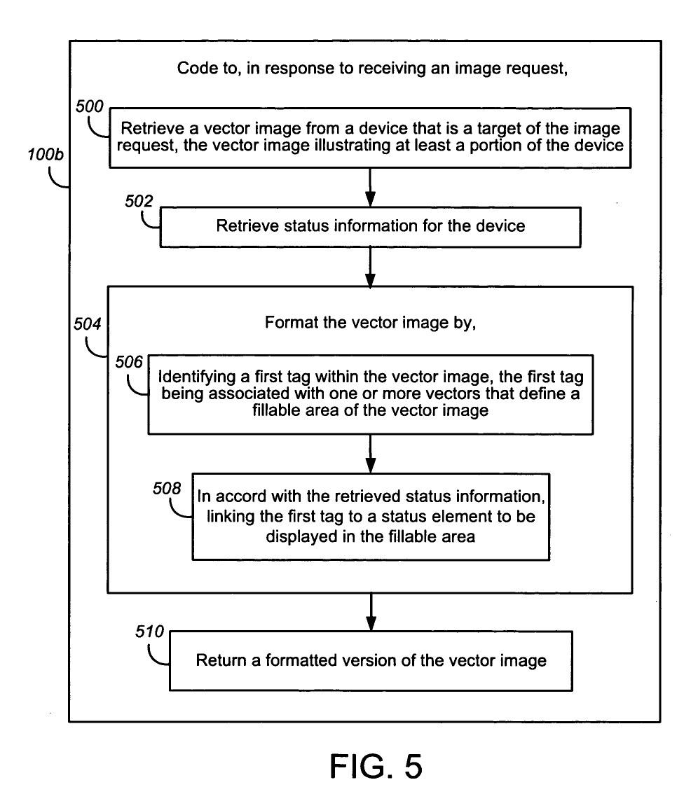

FIG. 5 illustrates a second embodiment 100b of the utility 100. The utility 100b comprises code 500, 502 to, in response to receiving an image request from a device management tool, 1) retrieve a vector image from a device that is a target of the image request, and 2) retrieve status information for the device. The utility 100b also comprises code 504 to format the vector image by A) identifying 506 a first tag within the vector image, the first tag being associated with one or more vectors that define a fillable area of the vector image, and B) in accord with the retrieved status information, linking 508 the first tag to a status element that is to be displayed in the fillable area. Additional code 510 is provided to return a formatted version of the vector image to the device management tool.

The utility 100b differs from the utility 100a in that, instead of replacing a first tag with a second tag, the first tag is merely linked to a desired status element. In one embodiment, the linking is accomplished by saving a desired status element in a file named to correspond to a file name that is already referenced in a vector image.

The status information retrieved by the utility 100 may comprise various sorts of information, including: whether a component is functioning, the degree to which a component is functioning, whether a component is present, or whether a component is enabled or disabled. In one embodiment, status queries issued by the code 202, 402 are made to the device from which a vector image is retrieved. Alternately (or additionally), the utility 100 may retrieve status information from an operating system that interfaces with the device, or from one or more management tools of which the utility 100 is aware.

In some cases, the formatted image returned by the code 210, 410 may comprise a formatted image that is in the native format of a retrieved vector image (e.g., an SVG format). In other cases, the formatting of a vector image may comprise rendering the image (i.e., converting the image to a raster-based format).

As previously indicated, the code 200-210 or 400-410 may be included within a utility 100 that stands apart from other management tools 104-108 and devices 110-114. Alternately, instances of the code 200-210 or 400-410 may be provided as part of the management tools 104-108, or may be stored and executed by the devices 110-114.

What is claimed is:

1. An image formatting utility, comprising:
code to, in response to receiving an image request,
retrieve a vector image from a device that is a target of the image request, the vector image illustrating at least a portion of the device;
retrieve status information for the device;
format the vector image by,
identifying a first tag within the vector image, the first tag being associated with one or more vectors that define a fillable area of the vector image; and
in accord with the retrieved status information, replacing the first tag with a second tag, the second tag identifying a status element to be displayed in the fillable area; and
return a formatted version of the vector image.

2. The image formatting utility of claim 1, wherein the second tag is a file name.

3. The image formatting utility of claim 1, wherein the second tag is a pointer to a subset of vectors within the vector image.

4. The image formatting utility of claim 1, wherein the vector image and status element are Scalable Vector Graphics (SVG) images.

5. The image formatting utility of claim 1, wherein the status element comprises a status icon.

6. The image formatting utility of claim 1, wherein the status element comprises text.

7. The image formatting utility of claim 1, wherein the status element is a raster image.

8. The image formatting utility of claim 1, wherein the fillable area defines a portion of the vector image that is displayed in pop-up form, upon user interaction with a display of the vector image.

9. The image formatting utility of claim 1, wherein the code to format the vector image receives the second tag from the device management tool.

10. The image formatting utility of claim 1, wherein, after the first tag is replaced with the second tag, the code to format the vector image renders the vector image.

11. An article of manufacture, comprising:
computer-readable media; and
computer-readable code, stored on the computer-readable media, including code to, in response to receiving an image request,
retrieve a vector image from a device that is a target of the image request, the vector image illustrating at least a portion of the device;
retrieve status information for the device;
format the vector image by,
identifying a first tag within the vector image, the first tag being associated with one or more vectors that define a fillable area of the vector image; and
in accord with the retrieved status information, replacing the first tag with a second tag, the second tag identifying a status element to be displayed in the fillable area; and
return a formatted version of the vector image.

12. An image formatting utility, comprising:
code to, in response to receiving an image request,
retrieve a vector image from a device that is a target of the image request, the vector image illustrating at least a portion of the device;
retrieve status information for the device;
format the vector image by,
identifying a first tag within the vector image, the first tag being associated with one or more vectors that define a fillable area of the vector image; and
in accord with the retrieved status information, linking the first tag to a status element to be displayed in the fillable area; and
return a formatted version of the vector image.

13. An article of manufacture, comprising:
computer-readable media; and
computer-readable code, stored on the computer-readable media, including code to, in response to receiving an image request,
retrieve a vector image from a device that is a target of the image request, the vector image illustrating at least a portion of the device;
retrieve status information for the device;
format the vector image by,
identifying a first tag within the vector image, the first tag being associated with one or more vectors that define a fillable area of the vector image; and
in accord with the retrieved status information, linking the first tag to a status element to be displayed in the fillable area; and
return a formatted version of the vector image.

14. A computer-implemented method for formatting images of a device, comprising:
in response to receiving an image request,
retrieving a vector image from a device that is a target of the image request;
retrieving status information for the device;
formatting the vector image by,
identifying a first tag within the vector image, the first tag being associated with one or more vectors that define a fillable area of the vector image; and
in accord with the retrieved status information, replacing the first tag with a second tag, the second tag identifying a status element to be displayed in the fillable area; and
returning a formatted version of the vector image.

15. A computer-implemented method for formatting images of a device, comprising:
in response to receiving an image request,
retrieving a vector image from a device that is a target of the image request;
retrieving status information for the device;
formatting the vector image by,
identifying a first tag within the vector image, the first tag being associated with one or more vectors that define a fillable area of the vector image; and
in accord with the retrieved status information, linking the first tag to a status element to be displayed in the fillable area; and
returning a formatted version of the vector image.

16. A device, comprising:
a non-volatile memory in which an image illustrating at least a portion of the device is stored, the image comprising a plurality of vectors and an tag, the tag i) being associated with one or more vectors that define a fillable area of the vector image, and ii) identifying a status element that is external to the vector image; and
an interface to, upon receiving a request for the vector image, return the vector image.

17. The device of claim 16, wherein the status element is saved in the non-volatile memory.

18. The device of claim 16, wherein the tag is a file name.

19. The device of claim 16, wherein the vector image is a Scalable Vector Graphics (SVG) image.

20. The device of claim 16, wherein the fillable area defines a portion of the vector image that is displayed in pop-up form, upon user interaction with a display of the vector image.

21. The device of claim 16, wherein the fillable area overlays other vectors of the vector image.
